(19) United States
(12) Patent Application Publication
(10) Pub. No.: US 2021/0381837 A1
(43) Pub. Date: Dec. 9, 2021

(54) APPARATUS AND METHOD OF SETTING NAVIGATION DESTINATION

(71) Applicants: HYUNDAI MOTOR COMPANY, Seoul (KR); KIA MOTORS CORPORATION, Seoul (KR)

(72) Inventors: Se Won Kim, Uiwang-si (KR); Woo Sok Yang, Gwangmyeong-si (KR)

(21) Appl. No.: 17/011,431

(22) Filed: Sep. 3, 2020

(30) Foreign Application Priority Data
Jun. 9, 2020 (KR) 10-2020-0069493

(51) Int. Cl. G01C 21/34; G06K 9/20; G06K 9/52; G06K 9/00; G01C 21/00; G01C 21/36

(52) U.S. Cl. CPC G01C 21/3407; G06K 9/2081; G06K 9/52; G06K 9/00832; G06K 2209/01; G01C 21/3664; G01C 21/3807; G01C 21/3608; G01C 21/3614; G01C 21/3833

(57) ABSTRACT

An apparatus for setting a navigation destination includes an image acquisition device configured to acquire a predetermined image, a vision-based recognition device configured to recognize a figure in the predetermined image and to determine a destination, a database configured to store map data, and a controller configured to control the image acquisition device and the vision-based recognition device, wherein, when receiving user input for requesting recognition of a rough map, the controller recognizes a region of the rough map from an image acquired by the image acquisition device and captures a rough map image, controls the vision-based recognition device to recognize the destination and a nearby place of the destination from the rough map image, and searches for a candidate of the destination from the database.

This application claims the benefit of Korean Patent Application No. 10-2020-0069493, filed on Jun. 9, 2020, which is hereby incorporated by reference as if fully set forth herein.

### TECHNICAL FIELD

The present disclosure relates to a navigation destination setting apparatus, and more particularly, to an apparatus and method of setting a navigation destination for recognizing a destination from a rough map image and setting a navigation destination.

### BACKGROUND

In general, a navigation device establishes a large amount of map information and road information in the form of a database (DB) to be searchable, includes a global positioning system (GPS) module to recognize a current position via communication with a satellite, and matches the recognized current position with the map information and the road information, which are established in the form of a DB to guide a driver through a path to a destination set by the driver in real time.

A navigation device may receive information on a business name, a lot number, or a telephone number of a destination from a user, may search for the destination using a key input device or a touchscreen, may search for a path to the found destination from a current position, may map-match the found path with map data, and may then guide the way along the path.

However, with regard to the navigation device, a user is inconvenienced by directly inputting information on a place name, a business name, an address, a telephone number, or a name of a destination one by one using a key input device or a touchscreen in order to search for the destination.

Accordingly, there is a need to develop an apparatus for setting a destination of a navigation device for recognizing a destination from a rough map image and automatically setting the destination of the navigation device.

### SUMMARY

An object of the present disclosure is to provide an apparatus and method of setting a navigation destination for recognizing a destination from a rough map image captured from an acquired image, automatically setting a navigation destination based on the recognized destination, thereby providing user convenience.

The technical problems solved by the embodiments are not limited to the above technical problems and other technical problems which are not described herein will become apparent to those skilled in the art from the following description.

To achieve these objects and other advantages and in accordance with the purpose of the disclosure, as embodied and broadly described herein, an apparatus for setting a navigation destination includes an image acquisition device configured to acquire a predetermined image, a vision-based recognition device configured to recognize a figure in the predetermined image and to determine a destination, a database configured to store map data, and a controller configured to control the image acquisition device and the vision-based recognition device. When receiving user input for requesting recognition of a rough map, the controller recognizes a region of the rough map from an image acquired by the image acquisition device and captures a rough map image, controls the vision-based recognition device to recognize the destination and a nearby place of the destination from the rough map image, searches for a candidate of the destination from the database, searches for a candidate of the nearby place from the database and calculates a distance between the candidate of the destination and the candidate of the nearby place when a number of the candidates of the destination is plural, selects a final candidate based on the calculated distance, and sets the final candidate to the navigation destination.

In another aspect of the present disclosure, a method of setting a navigation destination of an apparatus for setting a navigation destination including an image acquisition device and a controller configured to control an image acquisition device and a vision-based recognition device includes checking whether user input for requesting recognition of a rough map is received, by the controller, when receiving the user input, activating the image acquisition device, by the controller, acquiring a predetermined image, by the image acquisition device, recognizing a region of the rough map from the acquired image and capturing a rough map image, by the controller, recognizing a destination and a nearby place of the destination from the rough map image, by the vision-based recognition device, searching for a candidate corresponding to the destination, by the controller, checking whether a number of candidates of the destination is plural, by the controller, searching for a candidate of the nearby place when the number of the candidates of the destination is plural, by the controller, calculating a distance between the candidate of the destination and the candidate of the nearby place, by the controller, selecting a final candidate based on the calculated distance, by the controller, and setting the final candidate to the navigation destination, by the controller.

In another aspect of the present disclosure, a computer-readable recording medium having recorded thereon a program for executing a method of setting a navigation destination of an apparatus for setting a navigation destination performs procedures provided by a method of setting a navigation destination of an apparatus for setting a navigation destination.

In another aspect of the present disclosure, a vehicle includes an input device configured to receive user input for requesting recognition of a rough map, and a navigation destination setting apparatus configured to set a destination recognized from a rough map image to a navigation destination according to the user input. When receiving the user input, the navigation destination setting apparatus recognizes a region of the rough map from the acquired image and captures a rough map image, recognizes the destination and a nearby place of the destination from the rough map image, searches for a candidate of the destination from map data, searches for a candidate of the nearby place from the map data and calculates a distance between the candidate of the destination and the candidate of the nearby place when a number of the candidates of the destination is plural, selects a final candidate based on the calculated distance, and sets the final candidate to the navigation destination.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram for explaining a vehicle including a navigation destination setting apparatus according to an embodiment of the present disclosure;

FIG. 2 is a block diagram for explaining the configuration of a navigation destination setting apparatus according to an embodiment of the present disclosure;

FIG. 3 is a block diagram for explaining a configuration of a vision-based recognition device illustrated in FIG. 2;

FIG. 4 is a diagram for explaining a procedure of extracting a region including position information from a rough map image;

FIG. 5 is a diagram for explaining a procedure of recognizing a destination and a nearby place thereof from a region including position information of a rough map image; and

FIGS. 6 to 8 are flowcharts for explaining a method of setting a navigation destination according to an embodiment of the present disclosure.

### DETAILED DESCRIPTION

Exemplary embodiments of the present disclosure are described in detail so as for those of ordinary skill in the art to easily implement the present disclosure with reference to the accompanying drawings. However, the present disclosure may be implemented in various different forms and is not limited to these embodiments. To clearly describe the present disclosure, a part without concerning to the description is omitted in the drawings, and like reference numerals in the specification denote like elements.

Throughout the specification, one of ordinary skill would understand terms “include”, “comprise”, and “have” to be interpreted by default as inclusive or open rather than exclusive or closed unless expressly defined to the contrary. Further, terms such as “unit”, “module”, “device”, etc. disclosed in the specification mean elements for processing at least one function or operation, which may be implemented by hardware, software, or a combination thereof.

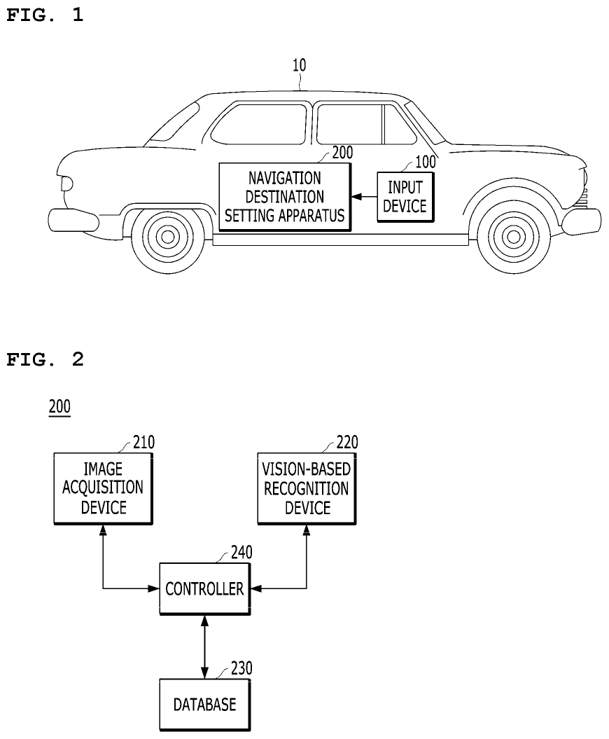

Hereinafter, an apparatus and method of setting a destination of a navigation device applicable to embodiments of the present disclosure will be described in detail with reference to FIGS. 1 to 8.

FIG. 1 is a diagram for explaining a vehicle including a navigation destination setting apparatus according to an embodiment of the present disclosure.

As shown in FIG. 1, a vehicle 10 may include an input device 100 for receiving user input for requesting recognition of a rough map, and a navigation destination setting apparatus 200 for setting a destination recognized from a rough map image to a navigation destination according to the user input.

Here, the input device 100 may include a manipulation system for receiving a user command for requesting recognition of the rough map or a microphone for receiving a rough map recognition voice command of the user, but the present disclosure is not limited thereto.

When receiving the user input, the navigation destination setting apparatus 200 may recognize a region of a rough map from an acquired image to capture a rough map image, may recognize a destination and a nearby place thereof from the rough map image, may search for candidates of the destination from map data, may calculate a distance between the candidates of the destination and candidates of the nearby place of the destination by searching for the candidates of the nearby place of the destination when there are a plurality of candidates of the destination, and may set a final candidate to a navigation destination by selecting the final candidate based on the calculated distance.

Here, while capturing the rough map image, when receiving user input for requesting recognition of the rough map, the navigation destination setting apparatus 200 may activate a camera, may provide a guide box for focusing on a rough map image from an image acquired by the camera, and may capture the rough map image by recognizing the region of the rough map positioned within the guide box when the region of the rough map of the acquired image is positioned within the guide box.

For example, the camera may be an indoor camera installed inside a vehicle, but the present disclosure is not limited thereto.

Then, when recognizing the destination and the nearby place thereof, the navigation destination setting apparatus 200 may extract a region including position information by recognizing texts and figures from the rough map image, may recognize a marked place and a text around the marked place in the region including position information, and may recognize the destination and the nearby thereof based on the marked place and the text around the marked place.

For example, when recognizing the destination, the navigation destination setting apparatus 200 may recognize the destination by comparing marked places based on at least one of a shape, a size, or color of the marked place.

Here, the navigation destination setting apparatus 200 may recognize a text corresponding to the most different marked place among the marked places as the comparison result of the marked places.

In another example, when recognizing the destination, the navigation destination setting apparatus 200 may also recognize the destination by comparing nearby texts based on at least one of the size or the font of a text around the marked place.

Here, the navigation destination setting apparatus 200 may also recognize the most different nearby text among the nearby texts as the comparison result of the nearby texts.

In another example, when recognizing the destination, the navigation destination setting apparatus 200 may compare marked places based on the shape, the size, and/or the color of the marked places to assign points to the respective marked places, may compare nearby texts of the marked place based on the size and/or the font of the nearby texts to assign points to the respective nearby texts, and may recognize the destination based on the assigned points.

Here, while assigning the points, the navigation destination setting apparatus 200 may assign a higher point to a more distinguishable marked place among the marked places and may assign a lower point to a less distinguishable marked place among the marked places.

The navigation destination setting apparatus 200 may recognize a text corresponding to a marked place to which the highest point is assigned or a nearby text to which the highest point is assigned, as the destination.

Then, while calculating a distance, the navigation destination setting apparatus 200 may check whether the number of the found candidates of the destination is plural, may search for a candidate corresponding to a nearby place from map data when the number of found candidates of the destination is plural, and may calculate a distance between the candidates of the destination and candidates of the nearby place.

Here, the navigation destination setting apparatus 200 may set the candidate of the destination to a navigation destination when the number of the found candidates of the destination is one.

While selecting a final candidate, the navigation destination setting apparatus 200 may select a candidate of a destination, located at the shortest distance from a candidate of the nearby place, as the final candidate based on the calculated distance.

As such, according to the present disclosure, the destination may be recognized from the rough map image captured from an acquired image, and a navigation destination may be automatically set based on the recognized destination, thereby providing user convenience.

The present disclosure may provide an interface for input to a navigation device based on an image using computer vision technology, thereby improving user convenience, and the accuracy and reliability of searching for a destination.

According to the present disclosure, an indoor camera may be used as an interface with a vehicle, and thus installation costs may be reduced without additional costs.

FIG. 2 is a block diagram for explaining the configuration of a navigation destination setting apparatus according to an embodiment of the present disclosure.

As shown in FIG. 2, the navigation destination setting apparatus 200 may include an image acquisition device 210 for acquiring a predetermined image, a vision-based recognition device 220 for recognizing a marking place and a nearby text thereof from a rough map image to determine a destination, a database 230 in which map data is stored, and a controller 240 for controlling the image acquisition device 210 and the vision-based recognition device 220.

Here, the image acquisition device 210 may be an indoor camera installed inside a vehicle, but the present disclosure is not limited thereto.

In this case, the image acquisition device 210 may be activated to acquire an image according to a control signal of the controller 240.

The vision-based recognition device 220 may recognize texts and figures from the rough map image to extract a region including position information, may recognize a marked place and a nearby text of the marked place in the region including position information, and may determine a destination and a nearby place thereof based on the marked place and the nearby text of the marked place.

Depending on the cases, the vision-based recognition device 220 may recognize figures, texts, and the like from an image obtained by entirely scanning an invitation card or the like as well as a rough map image, may calculate a horizontal range and a vertical range of a region for grouping the all recognized figures and may also divide the entire scan image into a region of a rough map including position information and the other region based on the calculated horizontal range and vertical range.

Here, when recognizing figures from the rough map image, the vision-based recognition device 220 may recognize figures indicating road information, destination information, and nearby building information from the rough map image.

While extracting the region including position information from the rough map image, when recognizing the figures, the vision-based recognition device 220 may calculate the horizontal range and the vertical range of the region for grouping the all recognized figures, and may extract the region including position information from the rough map image based on the calculated horizontal range and vertical range.

While recognizing the marked place and the nearby text of the marked place, the vision-based recognition device 220 may recognize the marked place by analyzing figures in the region including position information based on a pre-learned figure object, and may recognize nearby texts positioned around the recognized marked place.

Here, while recognizing the nearby texts, the vision-based recognition device 220 may recognize nearby texts positioned to the right and the left of and above and below the marked place.

While determining the destination, the vision-based recognition device 220 may determine the destination by comparing marked places based on at least one of the shape, the size, or color of the marked places.

Here, while determining the destination, the vision-based recognition device 220 may determine a text corresponding to the most different marked place among the marked places as the destination as the comparison result of the marked places.

For example, while determining the destination, the vision-based recognition device 220 may check whether a marked place having a different shape is present by comparing the shapes of a plurality of marked places, and may determine a text corresponding to the marked place having a different shape as the destination when the marked place having a different shape is present.

Here, while checking whether the marked place having a different shape is present, the vision-based recognition device 220 may check whether a marked place, any one of the size and the color of which is different, is present when the marked place having a different shape is not present, and may determine the destination based on the marked place, any one of the size and the color of which is different.

In another example, while determining the destination, the vision-based recognition device 220 may check whether a marked place having a different size by comparing the sizes of a plurality of marked places and may determine a text corresponding to the marked place having a different size as the destination when the marked place having a different size is present.

Here, while checking whether the marked place having a different size is present, the vision-based recognition device 220 may check whether a marked place, any one of the shape and the color of which is different, is present when the marked place having a different size is not present, and may determine the destination based on the marked place, any one of the shape and the color of which is different.

In another example, while determining the destination, the vision-based recognition device 220 may check whether a marked place having a different color by comparing the colors of a plurality of marked places and may determine a text corresponding to the marked place having a different color as the destination when the marked place having a different color is present.

Here, while checking whether the marked place having a different color is present, the vision-based recognition device 220 may check whether a marked place, any one of the shape and the size of which is different, is present when the marked place having a different color is not present, and may determine the destination based on the marked place, any one of the shape and the size of which is different.

Depending on the cases, while determining the destination, the vision-based recognition device 220 may also determine the destination by comparing nearby texts based on at least one of the size or the font of the nearby text of the marked place.

Here, while determining the destination, the vision-based recognition device 220 may determine the most different nearby text among the nearby texts as the destination as the comparison result of the nearby texts.

For example, while determining the destination, the vision-based recognition device 220 may check whether a nearby text having a different size is present by comparing the sizes of a plurality of nearby texts and may determine the nearby text having a different size as the destination when the nearby text having a different size is present.

Here, while checking whether the nearby text having a different size is present, the vision-based recognition device 220 may check whether a nearby text having a different font is present when the nearby text having a different size is not present and may determine the destination based on the nearby text having a different font.

In another example, while determining the destination, the vision-based recognition device 220 may check whether a nearby text having a different font is present by comparing the fonts of a plurality of nearby texts and may determine the nearby text having a different font as the destination when the nearby text having a different font is present.

Here, while checking whether the nearby text having a different font is present, the vision-based recognition device 220 may check whether a nearby text having a different size is present when the nearby text having a different font is not present and may determine the destination based on the nearby text having a different size.

In another example, while determining the destination, the vision-based recognition device 220 may compare marked places based on the shapes, the sizes, and the colors of the marked places to assign points to the respective marked places, may compare nearby texts based on the sizes and the fonts of the nearby texts of the marked place to assign points to the respective nearby texts, and may determine the destination as the assigned points.

Here, while assigning the points, the vision-based recognition device 220 may assign a higher point to a more distinguishable marked place among the marked places and may assign a lower point to a less distinguishable marked place among the marked places.

While determining the destination, the vision-based recognition device 220 may determine a text corresponding to a marked place to which the highest point is assigned or a nearby text to which the highest point is assigned, as the destination.

When receiving user input for requesting recognition of a rough map, the controller 240 may recognize a region of the rough map from an image acquired by the image acquisition device 210 to capture a rough map image, may the vision-based recognition device 220 to recognize the destination and the nearby place thereof from the rough map image, may search for candidates of the destination from the database 230, may calculate a distance between the candidates of the destination and candidates of the nearby place thereof by searching for the candidates of the nearby place thereof when there are a plurality of candidates of the destination, and may set a final candidate to a navigation destination by selecting the final candidate based on the calculated distance.

Here, while receiving user input, the controller 240 may receive the user input including a user command for requesting recognition of the rough map input through a manipulation system including, but not limited to, a touchscreen, touchpad, keyboard, key knob, or joystick, or through a rough map recognition voice command input through a microphone.

While capturing the rough map image, when receiving user input for requesting recognition of the rough map, the controller 240 may control the image acquisition device 210 to activate the image acquisition device 210, may provide a guide box for focusing on the rough map image from an acquired image when the image acquisition device 210 acquires the image, may recognize a region of the rough map positioned in the guide box when the region of the rough map of the acquired image is positioned in the guide box to capture the region of the rough map, and may provide the captured rough map image to the vision-based recognition device 220.

Then, while searching for candidates of the destination, the controller 240 may generate a list including the destination and the nearby place thereof based on the destination and the nearby place thereof recognized by the vision-based recognition device 220, and may search for candidates corresponding to the destination from the database 230.

Then, while calculating a distance, the controller 240 may check whether the number of the found candidates of the destination is plural, may search for a candidate corresponding to a nearby place of the destination from the database 230 when the number of the found candidates of the destination is plural, and may calculate a distance between the candidates of the destination and candidates of the nearby place.

While checking whether the number of the found candidates of the destination is plural, the controller 240 may set the found candidate of the destination to a navigation destination when the number of the found candidates of the destination is one.

While selecting the final candidate, the controller 240 may select a candidate of a destination, located at the shortest distance from a candidate of the nearby place, as the final candidate based on the calculated distance.

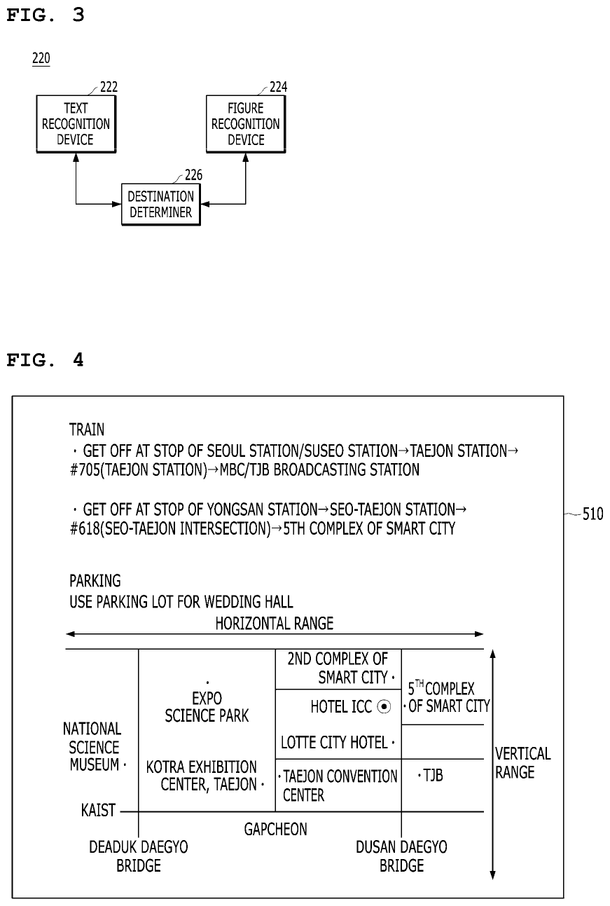

FIG. 3 is a block diagram for explaining the configuration of the vision-based recognition device illustrated in FIG. 2.

As shown in FIG. 3, the vision-based recognition device 220 may include a text recognition device 222 for recognizing a text from a rough map image, a figure recognition device 224 for recognizing a figure from the rough map image, and a destination determiner 226 for recognizing a marked place and a nearby text of the marked place based on the text and the figure recognized from the rough map image and determining a destination.

Here, the text recognition device 222 may recognize nearby texts positioned to the right and the left of and above and below the marked place.

The figure recognition device 224 may recognize figures indicating road information, destination information, and nearby building information from the rough map image.

Then, the destination determiner 226 may determine the destination by comparing marked places based on at least one of the shape, the size, or the color of the marked places.

Depending on the cases, the destination determiner 226 may also determine the destination by comparing the nearby texts based on the at least one of the size or the font of the nearby text of the marked place.

In another example, the destination determiner 226 may compare marked places based on the shape, the size, and the color of the marked places to assign points to the respective marked places, may compare nearby texts of the marked place based on the size and the font of the nearby texts to assign points to the respective nearby texts, and may determine the destination based on the assigned points.

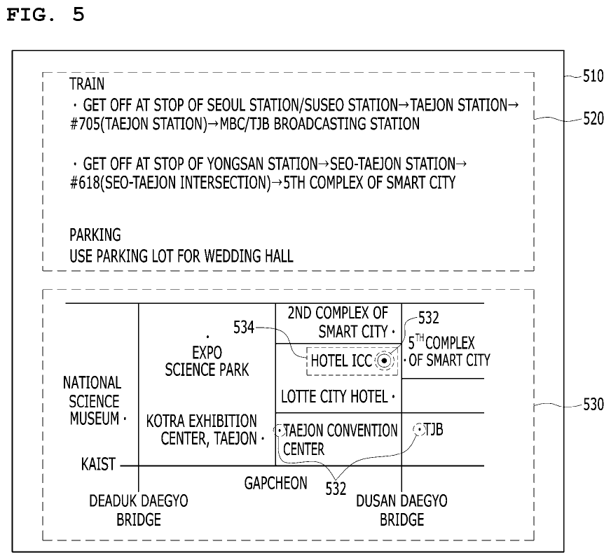

FIG. 4 is a diagram for explaining a procedure of extracting a region including position information from a rough map image. FIG. 5 is a diagram for explaining a procedure of recognizing a destination and a nearby place thereof from a region including position information of a rough map image.

As shown in FIGS. 4 and 5, a vision-based recognition device according to the present disclosure may recognize a text and a figure from a rough map image 510 and may separate a text region 520 and a region including position information 530 from the rough map image 510 based on the recognized text and figure and may extract the region including position information 530.

Here, as shown in FIG. 4, the vision-based recognition device may recognize a figure from the rough map image 510, may calculate the horizontal range and the vertical range of the region for grouping the all recognized figures, and may extract the region including position information from the rough map image based on the calculated horizontal range and vertical range.

For example, as shown in FIG. 5, the rough map image 510 may include the text region 520 that is a region indicating information on transportation or weather and the region including position information 530 that is a region for providing visual information of a destination using a figure and a text.

Then, the vision-based recognition device may recognize a marked place 532 and a nearby text 534 of the marked place 532 in the region including position information 530 and may determine the destination and the nearby place thereof based on the recognized marked place 532 and the recognized marked place 532.

For example, the vision-based recognition device may recognize a round dot, a box, and a shape of a building as the marked place 532 in the region including position information 530.

That is, the vision-based recognition device may pre-learn road information using a straight line, a rectangular shape, or the like and may recognize a figure object except for a text and the pre-learned road information in the region including position information 530 as the marked place 532.

Then, the vision-based recognition device may recognize texts positioned to the right and the left of and above and below the recognized marked place 532 and may determine the destination.

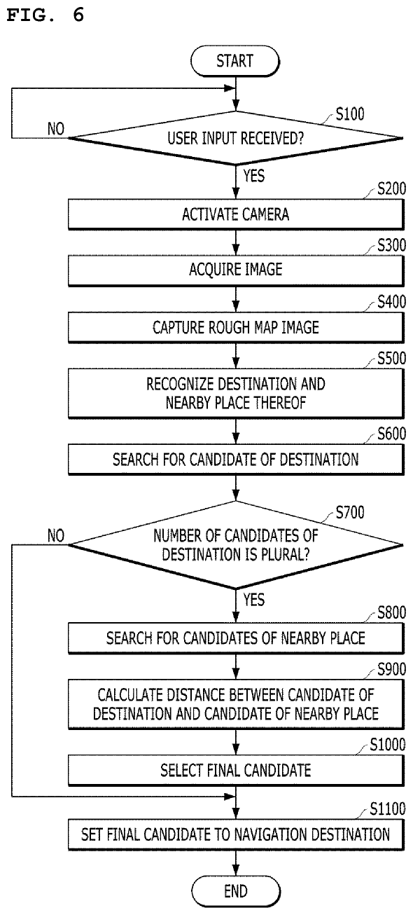

FIGS. 6 to 8 are flowcharts for explaining a method of setting a navigation destination according to an embodiment of the present disclosure.

As shown in FIG. 6, according to the present disclosure, whether user input for requesting recognition of a rough map is received may be checked (S100).

According to the present disclosure, when the user input is received, a camera may be activated (S200).

Then, according to the present disclosure, a predetermined image may be acquired from the camera (S300).

Then, according to the present disclosure, a region of a rough map may be recognized from the acquired image and a rough map image may be captured (S400).

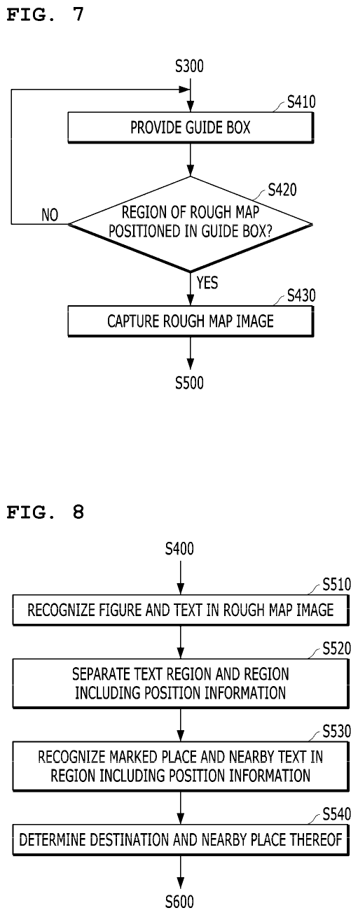

Here, according to the present disclosure, as shown in FIG. 7, when the rough map image is captured, a guide box for focusing on the rough map image may be provided from the acquired image (S410), whether the region of the rough map of the acquired image is positioned in the guide box may be checked (S420), and when the region of the rough map is positioned in the guide box, the region of the rough map positioned in the guide box may be recognized and the rough map image may be captured (S430).

According to the present disclosure, a destination and a nearby place thereof may be recognized from the rough map image (S500).

Here, according to the present disclosure, as shown in FIG. 8, while the destination and the nearby place thereof are recognized, a text and a figure may be recognized from the rough map image (S510), a text region and a region including position information may be separated from the rough map image and the region including position information may be extracted (S520), a marked place and a nearby text thereof may be recognized in the region including position information (S530), and a destination and a nearby place thereof may be determined based on the recognized marked place and the recognized nearby text thereof (S540).

For example, according to the present disclosure, while the destination is determined, the destination may be determined by comparing the marked places based on at least one of the shape, the size, or the color of the marked place.

In another example, according to the present disclosure, when the destination is determined, the destination may be determined by comparing the nearby texts based on at least one the size and the font of the nearby text of the marked place.

In another example, according to the present disclosure, when the destination is determined, marked places may be compared based on the shape, the size, and the color of the marked places and points may be assigned to the respective marked place, nearby texts of the marked place may be compared based on the size and the font of the nearby texts and points may be assigned to the respective nearby texts, and the destination may be determined based on the assigned point.

Then, according to the present disclosure, candidates corresponding to the destination may be searched for (S600).

Then, according to the present disclosure, whether the number of the found candidates of the destination is plural may be checked (S700).

According to the present disclosure, when the number of found candidates of the destination is plural, the candidates of the nearby place may be searched for (S800).

Here, according to the present disclosure, when the number of the found candidates of the destination is one, the found candidate of the destination may be set to the navigation destination (S1100).

Then, according to the present disclosure, a distance between the candidates of the destination and candidates of the nearby place may be calculated (S900).

Then, according to the present disclosure, a final candidate may be selected based on the calculated distance (S1000).

Here, according to the present disclosure, a candidate of a destination, located at the shortest distance from a candidate of the nearby place, may be selected as the final candidate based on the calculated distance.

According to the present disclosure, the final candidate may be set to the navigation destination (S1100).

As such, according to the present disclosure, the destination may be recognized from the rough map image captured from an acquired image, and a navigation destination may be automatically set based on the recognized destination, thereby providing user convenience.

The present disclosure may provide an interface for input to a navigation device based on an image using computer vision technology, thereby improving user convenience, and the accuracy and reliability of searching for a destination.

According to the present disclosure, an indoor camera may be used as an interface with a vehicle, and thus installation costs may be reduced without additional costs.

According to the present disclosure, a computer-readable recording medium having recorded thereon a program for executing a method of setting a navigation destination of an apparatus for setting a navigation destination may perform procedures provided by a method of setting a navigation destination of an apparatus for setting a navigation destination according to an embodiment of the present disclosure, when the controller and/or the components thereof and the vision-based recognition device execute the recorded program. The controller and/or the components thereof and the vision-based recognition device and/or the components thereof each, or together, may be implemented as a computer, a processor, or a microprocessor. When the controller and/or the components thereof and the vision-based recognition device and/or the components thereof read and execute the recorded program, the controller and/or the components thereof and the vision-based recognition device may be configured to perform the method of setting a navigation destination of an apparatus for setting a navigation destination.

The aforementioned present disclosure can also be embodied as computer-readable code stored on a computer-readable recording medium. The computer-readable recording medium is any data storage device that can store data which can thereafter be read by a computer. Examples of the computer-readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc.

The apparatus and method of setting a navigation destination related to at least one embodiment of the present disclosure as configured above may recognize the destination from the rough map image captured from an acquired image, and may automatically set the navigation destination based on the recognized destination, thereby providing user convenience.

The present disclosure may provide an interface for input to a navigation device based on an image using computer vision technology, thereby improving user convenience, and the accuracy and reliability of searching for a destination.

According to the present disclosure, an indoor camera may be used as an interface with a vehicle, and thus installation costs may be reduced without additional costs.

It will be appreciated by persons skilled in the art that that the effects that could be achieved with the present disclosure are not limited to what has been particularly described hereinabove and other advantages of the present disclosure will be more clearly understood from the detailed description.

It will be apparent to those skilled in the art that various modifications and variations can be made in the present disclosure without departing from the spirit or scope of the embodiments. Thus, it is intended that the present disclosure cover the modifications and variations of the embodiment provided they come within the scope of the appended claims and their equivalents.

What is claimed is:

1. An apparatus for setting a navigation destination, comprising:
an image acquisition device configured to acquire a predetermined image;
a vision-based recognition device configured to recognize a figure in the predetermined image and to determine a destination;
a database configured to store map data; and
a controller configured to control the image acquisition device and the vision-based recognition device,
wherein, when receiving user input for requesting recognition of a rough map, the controller recognizes a region of the rough map from an image acquired by the image acquisition device and captures a rough map image, controls the vision-based recognition device to recognize the destination and a nearby place of the destination from the rough map image, searches for a candidate of the destination from the database, searches for a candidate of the nearby place from the database and calculates a distance between the candidate of the destination and the candidate of the nearby place when a number of the candidates of the destination is plural, selects a final candidate based on the calculated distance, and sets the final candidate to the navigation destination.

2. The apparatus of claim 1, wherein the image acquisition device is an indoor camera installed in the vehicle.

3. The apparatus of claim 1, wherein the vision-based recognition device recognizes a text and a figure from the rough map image, extracts a region including position information, recognizes a marked place and a nearby text of the marked place in the region including position information, and determines the destination and the nearby place of the destination based on the marked place and the nearby text of the marked place.

4. The apparatus of claim 3, wherein, while extracting the region including position information from the rough map image, when recognizing the figure, the vision-based recognition device calculates a horizontal range and a vertical range of a region for grouping the all recognized figures, and extracts the region including position information from the rough map image based on the calculated horizontal range and vertical range.

5. The apparatus of claim 3, wherein, when recognizing the marked place and the nearby text of the marked place, the vision-based recognition device recognizes the marked place by analyzing figures in the region including position information based on a pre-learned figure object, and recognizes a nearby text positioned around the recognized marked place.

6. The apparatus of claim 3, wherein, while determining the destination, the vision-based recognition device determines the destination by comparing the marked places based on at least one of a shape, a size, or a color of the marked place.

7. The apparatus of claim 3, wherein, while determining the destination, the vision-based recognition device determines the destination by comparing the nearby texts of the marked place based on at least one of a size or a font of the nearby text.

8. The apparatus of claim 1, wherein the vision-based recognition device comprises:
a text recognition device configured to recognize a text from the rough map image;
a figure recognition device configured to recognize a figure from the rough map image; and
a destination determiner configured to recognize a marked place and a nearby text of the marked place based on the recognized text and figure from the rough map image and to determine the destination.

9. The apparatus of claim 1, wherein, while capturing the rough map image, when receiving user input for recognition of the rough map, the controller controls the image acquisition device to activate the image acquisition device, provides a guide box focusing on the rough map image of the acquired image when the image acquisition device acquires the image, recognizes a region of the rough map, positioned in the guide box, and captures the rough map image when the region of the rough map of the acquired image is positioned in the guide box, and provides the captured rough map image to the vision-based recognition device.

10. The apparatus of claim 1, wherein, while calculating the distance, the controller checks whether the number of the found candidates of the destination is plural, searches for the candidate corresponding to the nearby place of the destination from the database when the number of the found candidates of the destination is plural, and calculates the distance between the candidate of the destination and the candidate of the nearby place.

11. The apparatus of claim 1, wherein, while checking whether the number of the found candidates of the destination is plural, the controller sets the found candidate of the destination to a navigation destination when the number of the found candidates of the destination is one.

12. The apparatus of claim 1, wherein, while selecting the final candidate, the controller selects a candidate of the destination, located at a shortest distance from a candidate of the nearby place, as the final candidate based on the calculated distance.

13. A method of setting a navigation destination of an apparatus for setting a navigation destination including an image acquisition device and a controller configured to control an image acquisition device and a vision-based recognition device, the method comprising:
checking whether user input for requesting recognition of a rough map is received, by the controller;
when receiving the user input, activating the image acquisition device, by the controller;
acquiring a predetermined image, by the image acquisition device;
recognizing a region of the rough map from the acquired image and capturing a rough map image, by the controller;
recognizing a destination and a nearby place of the destination from the rough map image, by the vision-based recognition device;
searching for a candidate corresponding to the destination, by the controller;
checking whether a number of candidates of the destination is plural, by the controller;
searching for a candidate of the nearby place when the number of the candidates of the destination is plural, by the controller;
calculating a distance between the candidate of the destination and the candidate of the nearby place, by the controller;
selecting a final candidate based on the calculated distance, by the controller; and
setting the final candidate to the navigation destination, by the controller.

14. The method of claim 13, wherein the capturing the rough map image comprises:
providing a guide box for focusing on the rough map image from the acquired image;
checking whether the region of the rough map of the acquired image is positioned in the guide box;
when the region of the rough map is positioned in the guide box, recognizing the region of the rough map positioned in the guide box and capturing the rough map image; and
providing the captured rough map image to the vision-based recognition device.

15. The method of claim 13, wherein the recognizing the destination and the nearby place of the destination comprises:
recognizing a text and a figure from the rough map image;
separating a text region and a region including position information from the rough map image and extracting the region including position information;
recognizing a marked place and a nearby text of the marked place in the region including position information; and
determining the destination and the nearby place of the destination based on the marked place and the nearby text of the marked place.

16. The method of claim 15, wherein the determining the destination comprises determining the destination by comparing marked places based on at least one of a shape, a size, or a color of the marked place.

17. The method of claim 15, wherein the determining the destination comprises determining the destination by comparing nearby texts based on at least one of a size or a font of a nearby text of the marked place.

18. The method of claim 13, wherein the checking whether the number of the candidates of the destination is plural comprises setting the found candidate of the destination to a navigation destination when the number of the found candidates of the destination is one.

19. The vehicle of claim 13, wherein the selecting the final candidate comprises selecting a candidate of the destination, located at a shortest distance from a candidate of the nearby place, as the final candidate based on the calculated distance.

20. A vehicle comprising:
an input device configured to receive user input for requesting recognition of a rough map; and
a navigation destination setting apparatus configured to set a destination recognized from a rough map image to a navigation destination according to the user input,
wherein, when receiving the user input, the navigation destination setting apparatus recognizes a region of the rough map from the acquired image and captures a rough map image, recognizes the destination and a nearby place of the destination from the rough map image, searches for a candidate of the destination from map data, searches for a candidate of the nearby place from the map data and calculates a distance between the candidate of the destination and the candidate of the nearby place when a number of the candidates of the destination is plural, selects a final candidate based on the calculated distance, and sets the final candidate to the navigation destination.

21. The vehicle of claim 20, wherein the input device comprises a manipulation system configured to receive a user command for requesting recognition of the rough map or a microphone configured to receive a rough map recognition voice command of the user.
